(19) United States
(12) Patent Application Publication
(10) Pub. No.: US 2021/0270998 A1
(43) Pub. Date: Sep. 2, 2021

(54) AUTOMATED PRODUCTION HISTORY MATCHING USING BAYESIAN OPTIMIZATION

(71) Applicant: LANDMARK GRAPHICS CORPORATION, HOUSTON, TX (US)

(72) Inventors: Srinath Madasu, Houston, TX (US); Keshava Prasad Rangarajan, Sugarland, TX (US); Terry Wong, Spring, TX (US)

(21) Appl. No.: 17/260,541

(22) PCT Filed: Aug. 30, 2018
(86) PCT No.: PCT/US2018/048935

§ 371 Date: Jan. 14, 2021

(51) Int. Cl. G01V 99/00; E21B 43/16; G06F 30/20; G06N 7/00

(52) U.S. Cl. CPC G01V 99/005; E21B 43/16; G06F 2113/08; G06N 7/005; E21B 2200/20; G06F 30/20

(57) ABSTRACT

A history-matched oilfield model that facilitates well system operations for an oilfield is generated using a Bayesian optimization of adjustable parameters based on an entire production history. The Bayesian optimization process includes stochastic modifications to the adjustable parameters based on a prior probability distribution for each parameter and a model error generated using historical production measurement values and corresponding model prediction values for various sets of test parameters.

### TECHNICAL FIELD

The present description relates in general to oil and gas production, and more particularly, for example and without limitation, to automated production history matching using Bayesian optimization.

### BACKGROUND OF THE DISCLOSURE

Computer-generated models of subsurface reservoirs, such as reservoirs of petroleum, water, and/or gas, are used by petroleum producers, for example, in determining how best to control production of existing wells, develop new fields, as well as in generating production forecasts for developed fields on which investment decisions are based. The models can include adjustable parameters that describe three-dimensional spatial characteristics of the reservoir, one or more fractures therein, and/or dynamic features of a well system such as fluid flow and pressure characteristics at various locations within the reservoir and/or well system components.

History matching is sometimes used to tune the parameters of a model, by comparing historical measurements, obtained by the well system, with predictions from the model for those historical measurements. However, conventional history matching techniques commonly require weeks to obtain history-match model parameters, and are often unable to incorporate data for the entire available history, nor for very recent measurement such as real-time measurements, particularly due to the computational costs of using the entire history of data.

The description provided in the background section should not be assumed to be prior art merely because it is mentioned in or associated with the background section. The background section may include information that describes one or more aspects of the subject technology.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 illustrates an example of a production well suitable for hydrocarbon production and exploration from a subsurface reservoir in accordance with some implementations.

FIG. 2 illustrates a flowchart of an example process for oilfield modeling using Bayesian optimization in accordance with some implementations.

FIG. 3 illustrates an exemplary drilling assembly for implementing the processes described herein in accordance with some implementations.

FIG. 4 illustrates a wireline system suitable for implementing the processes described herein in accordance with some implementations.

FIG. 5 illustrates a schematic diagram of a set of general components of an example computing device in accordance with some implementations.

FIG. 6 illustrates a schematic diagram of an example of an environment for implementing aspects in accordance with some implementations.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The present disclosure relates to improving and/or optimizing production of wells in petroleum reservoirs by generating history-matched oilfield models using Bayesian optimization of adjustable model parameters based on an entire history of a well system or portion thereof.

Oil and gas hydrocarbons naturally occur in some subterranean formations. In the oil and gas industry, a subterranean formation containing oil, gas, or water is referred to as a reservoir. A reservoir may be located under land or off shore. Reservoirs are typically located in the range of a few hundred feet (shallow reservoirs) to a few tens of thousands of feet (ultra-deep reservoirs). In order to produce oil or gas, a wellbore is drilled into a reservoir or adjacent to a reservoir. The oil, gas, or water produced from the wellbore is called a reservoir fluid. An oil or gas well system can be on land or offshore.

An oilfield model may include adjustable parameters that describe physical characteristics of the reservoir, adjustable parameters that describe fluid flow and/or pressure characteristics within the reservoir and/or within production wells, injection wells, fractures or other well system components, and/or adjustable parameters that describe the well system components (e.g., a number, location, depth, aperture size, etc. of one or more wellbores, fractures, etc.).

The history-matched oilfield model may be used to identify or modify a location for one or more injection wells or one or more production wells, and/or to modify current and/or future injection well operations to increase current or future production at one or more production wells.

Implementations of the subject technology provide a tool for petroleum reservoir engineers and reservoir managers to quickly and accurately predict future reservoir performance and to improve or optimize hydrocarbon production in a timely manner (e.g., in real time). The history matching may use measured values such as measured surface flow rates and/or measured surface pressures at multiple historical times including, for example, the entire history of a well or a well system up through a most-recent measure valued such as a current measured value. Current measured values may include a measured surface flow rate and/or a measure surface pressure obtained within a current time window such as within a second, a minute, an hour, a day, a week, or a month of a current real time.

Measured values for Bayesian optimization history matching may also include a water production rate, an injection rate, a bottomhole pressure, or other measured data such as core samples, well logs, seismic data, electromagnetic data, and/or gravimetric survey data obtained repeatedly in the same area over the time. Predictions of future reservoir performance and/or characteristics are generated automatically using the Bayesian optimization operations described herein, and can be used to modify current and/or future well operations.

In an example scenario, performing history matching using an existing tool (e.g., one that does not utilize the Bayesian optimization operations described herein), executing such a history matching operation may take a longer amount of time (e.g., days or weeks) than the Bayesian optimization history matching described herein, which may be performed and applied to well operations in real time (e.g., within minutes or less of an optimization run commencing, for example, when new historical data becomes available). The history matching operations described herein facilitate improving the production of fluids from a production well of a reservoir, facilitate a determination of whether to perform a drilling operation with respect to the reservoir and/or other operations related to the reservoir (e.g., injection of fluids). The subject technology improves the parameters of an original oilfield/reservoir model to provide an improved, history-matched, oilfield/reservoir model, which may include production estimates and/or well system characteristics for one or more future times. Additionally, the Bayesian optimization history matching described herein may increase the speed and/or reduce computational resources used for performing history matching.

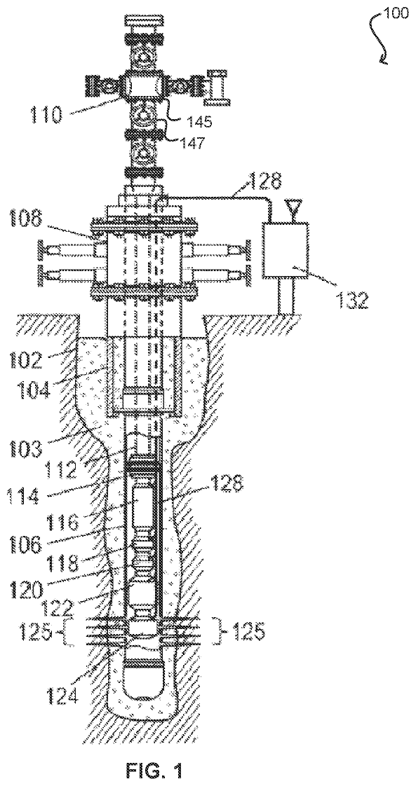

In an implementation, the oilfield model may be based in part on known or measured geophysical/geologic and seismic properties of the oilfield and/or on well system data including various measurements collected downhole from one or more wells drilled within a reservoir in the oilfield (e.g., in the form of a production well for an oil and gas reservoir). Further, multiple production wells may be drilled for providing access to the reservoir fluids underground. Measured values such as surface flow rate values and/or surface pressures may be collected regularly from each production well, as will be described in further detail below with respect to a production well example as illustrated in FIG. 1.

Petroleum reservoirs are typically geologically complex and large in size. In order to facilitate oil and gas recovery, oilfield models including reservoir features and/or well system features are generated. In an example, oilfield models may be developed and parameterized based on, for example, geophysical data and production data. Geophysical data, such as seismic and wireline logs, may provide ranges for model parameters that describe physical properties (e.g., porosity or permeability) of one or more portions of the reservoir. Production data (e.g., measured water saturation and pressure information such as downhole pressures) may provide ranges for model parameters that describe the fluid flow dynamics of the reservoir and/or well system components for the reservoir.

FIG. 1 is a diagram of an exemplary production well 100 with a borehole 102 that has been drilled into a reservoir formation. Borehole 102 may be drilled to any depth and in any direction within the formation. For example, borehole 102 may be drilled to ten thousand feet or more in depth and further, may be steered horizontally for any distance through the formation, as desired for a particular implementation. The production well 100 also includes a casing header 104 and a casing 106, both secured into place by cement 103. A blowout preventer 108 couples to casing header 104 and a production wellhead 110, which together seal in the well head and enable fluids to be extracted from the well in a safe and controlled manner.

Measured well data corresponding to the aforementioned geophysical and/or production data may be periodically sampled and collected from the production well 100 and combined with measurements from other wells within a reservoir, enabling the overall state of the reservoir to be monitored and assessed. Such measurements may be taken using a number of different downhole and surface instruments, including but not limited to, a downhole temperature and pressure sensor 118 and a downhole flow meter 120. Additional devices may also be coupled in-line to a production tubing 112 including, for example, a downhole choke 116 (e.g., for varying a level of fluid flow restriction), an electric submersible pump (ESP) 122 (e.g., for drawing in fluid flowing from perforations 125 outside ESP 122 and production tubing 112), an ESP motor 124 (e.g., for driving ESP 122), and a packer 114 (e.g., for isolating the production zone below the packer from the rest of well 100). Additional surface measurement devices such a surface flow meter 145 and a surface pressure sensor 147 may be used to measure, for example, a surface flow rate, a surface pressure (e.g., the tubing head pressure) and/or aspects of the well system such as the electrical power consumption of ESP motor 124. Surface flow meter 145 and surface pressure sensor 147 may be communicatively coupled to control unit 132 and/or one or more remote computing devices via a wired or wireless connection.

Geophysical measurements and/or downhole production measurements such as measurements of downhole pressure and/or flow rates can, in some scenarios, be disruptive to production and/or difficult or expensive to obtain continuously. Accordingly, these measurements may be obtained at or before the production stage of a well system (e.g., before, during, or after drilling) and/or only periodically (e.g., monthly) during the production stage. These measurements may be used to identify parameters of an oilfield model and to provide prior probability distributions such as ranges or weighted ranges for each parameter.

In many scenarios, surface measurements such as surface flow rates and surface pressures can be more easily obtained throughout the history of a well system (e.g., continuously). Although these surface measurements are not direct measurements of oilfield characteristics such as porosity or permeability, the value of these measurements increases with time (e.g., over the history of the well system) for constraining model parameters that describe these oilfield characteristics.

In accordance with various aspects of the subject disclosure, Bayesian optimization of oilfield model parameters (e.g., using the prior probability distributions for each parameter based on other data) facilitates using the entire set of historical surface data for history matching, which can improve the accuracy of oilfield models, reduce the computational cost for computing such models, and provide the models in (or close to) real time for well placement and/or control operations (e.g., for determining the amount, rate, or pressure of fluid to be injected at current or future times through an injection well).

Conventional history matching is commonly performed using a recent portion of the history, while ignoring earlier portions of the historical data. However, the Bayesian optimization operations described herein increase the speed with which a model can be computed such that the entire history can be used to constrain the model parameters (e.g., in real time).

Although various example components of the production well 100 are discussed above, it is appreciated that operations related to measuring well data may apply to other components of the production well 100 than those discussed and/or shown in FIG. 1. For example, measured well data may be provided from components such as a crown block and water table, catline boom and hoist line, drilling line, monkeyboard, traveling block, mast, doghouse, water tank, electric cable tray, engine generator sets, fuel tanks, electric control house, bulk mud components storage, reserve pits, mud gas separator, shale shaker, choke manifold, pipe ramp, pipe racks, accumulator, and/or among other types of components of the production well 100. In implementations described herein, well data may be provided by any of the components described herein in connection with the production well 100, and compared with model predictions during a Bayesian optimization process.

As shown in FIG. 1, a device along production tubing 112 couples to a cable 128, which may be attached to an exterior portion of production tubing 112. Cable 128 may be used primarily to provide power to the devices to which it couples. Cable 128 also may be used to provide signal paths (e.g., electrical or optical paths), through which control signals may be directed from the surface to the downhole devices as well as telemetry signals from the downhole devices to the surface. The respective control and telemetry signals may be sent and received by a control unit 132 at the surface of the production well. Control unit 132 may be coupled to cable 128 through blowout preventer 108.

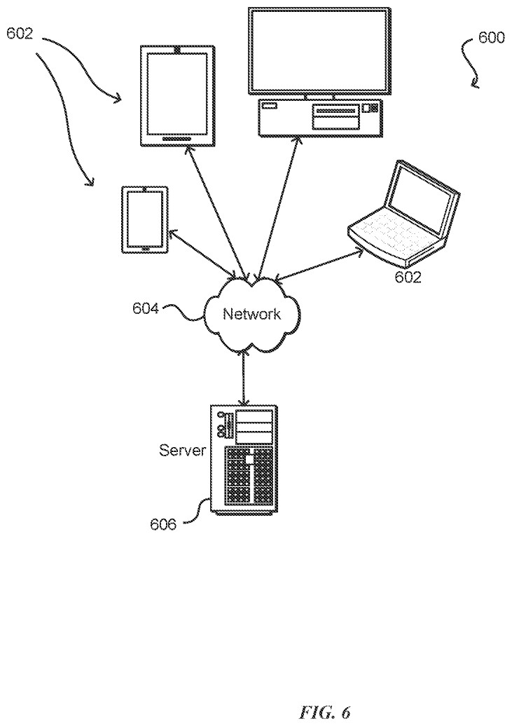

In an implementation, control unit 132 may be used to control and monitor surface measurement devices 145 and 147 and/or downhole devices locally and to provide information associated with model predictions and/or measured data (e.g., via a user interface provided at a terminal or control panel integrated with control unit 132). Additionally or alternatively, downhole devices may be controlled and monitored by a remote processing system (see, e.g., FIG. 6). A local or remote processing system may be used to provide various supervisory control and data acquisition (SCADA) functionality for the production wells associated with each reservoir in a field. For example, a remote processing system may receive surface measurement data from control unit 132, update the model parameters of an oilfield model using the Bayesian optimization operations described herein, and generate and send appropriate commands for controlling wellsite operations to control unit 132. Communication between control unit 132 and a remote processing system may be via one or more communication networks, e.g., in the form of a wireless network (e.g., a cellular network), a wired network (e.g., a cabled connection to the Internet) or a combination of wireless and wired networks.

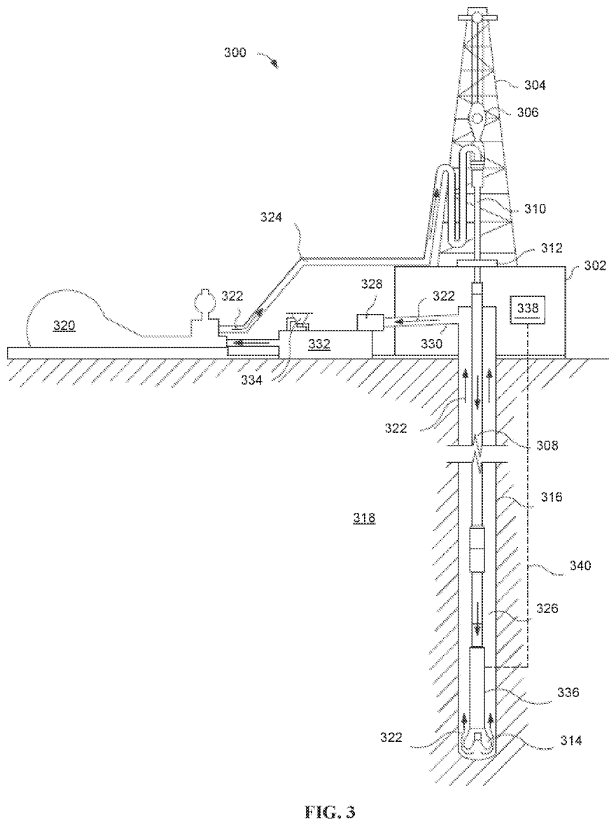

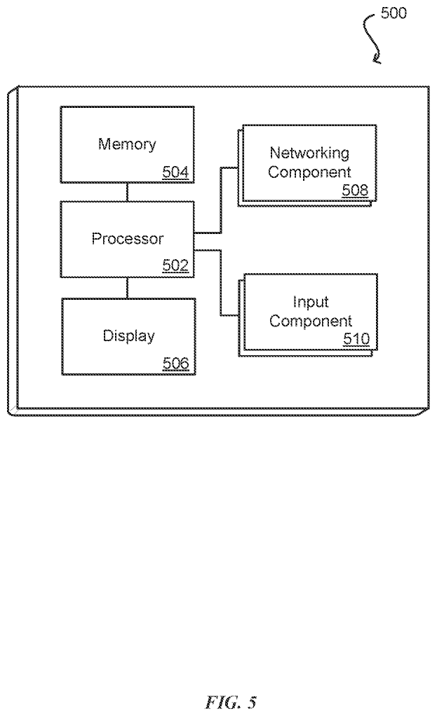

In one or more implementations, such a processing system may include a computing device (e.g., a server) and a data storage device (e.g., a database). Such a computing device may be implemented using any type of computing device having at least one processor, a memory and a networking interface capable of sending and receiving data to and from control unit 132 via a communication network, such as a processor 338 described in FIG. 3, the computing device 500 described hereinafter in connection with FIG. 5, and/or the server 606 described hereinafter in connection with FIG. 6.

In an implementation, control unit 132 may periodically send wellsite production data via a communication network to the processing system for processing and storage. Such wellsite production data may include, for example, production system measurements from various downhole devices or surface sensors/meters, as described above. In some implementations, such production data may be sent using a remote terminal unit (RTU) of control unit 132. In an implementation, a local or remote data storage device may be used to store the production data received from control unit 132. In an example, the local or remote data storage device may be used to store historical production data including a record of actual and simulated production system measurements (e.g., including surface pressure measurements and surface flow rate measurements) obtained or calculated over a period of time, e.g., at multiple historical times. While the production well 100 is described in the context of a single reservoir, it should be noted that the implementations disclosed herein are not limited thereto and that the disclosed implementations may be applied to fluid production from multiple reservoirs in a multi-reservoir production system.

In one or more implementations, Bayesian optimization history matching as described herein can facilitate computation and application of oilfield models that utilize measurements across the entire history of an oilfield, reservoir or well due to the rapid driving of parameter values to optimum or near optimum values using the prior probability distributions and the stochastic (e.g., Bayesian) processes.

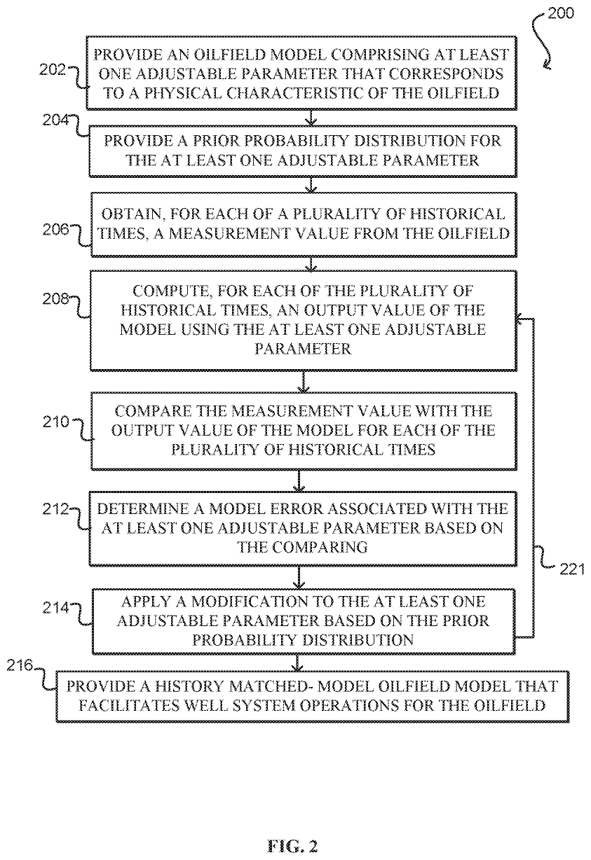

FIG. 2 illustrates an example flowchart of a process 200 for Bayesian optimization of an oilfield mode in accordance with some implementations. Although FIG. 2, as well as other process illustrations contained in this disclosure may depict functional steps or operations in a particular sequence, the processes are not necessarily limited to the particular order or steps illustrated. The various steps and/or operations portrayed in this or other figures can be changed, rearranged, performed in parallel or adapted in various ways. Furthermore, it is to be understood that certain steps or sequences of steps can be added to or omitted from the process, without departing from the scope of the various implementations. The process 200 may be implemented by one or more computing devices or systems in some implementations, such as processor 338 described in FIG. 3, a computing device 500 described in FIG. 5, and/or client device 602 or server 606 described in FIG. 6.

At block 202, an oilfield model may be provided for an oilfield. The oilfield model may include at least one adjustable parameter that corresponds to a physical characteristic of the oilfield. The oilfield includes one or more subsurface reservoirs of oil and/or gas and a well system including one or more production wells and/or one or more injection wells. The at least one adjustable parameter may include one or more geophysical parameters, one or more well system parameters, and/or one or more fluid parameters.

Geophysical parameters may be parameters that describe characteristics of a reservoir in the oilfield (e.g., a permeability and/or a porosity of a formation layer or other component of a reservoir or a portion of a reservoir, a number of formation layers, a thickness or other spatial characteristic of a formation layer, or the like). Fluid parameters may include parameters that describe fluid flow, pressure, or composition in the reservoir and/or well system such as a water saturation value or a pressure such as a downhole pressure (e.g., bottom-hole pressure associated with a production well in the oilfield) or other pressure in the reservoir and/or well system. Well system parameters may include, for example, a number of fractures, a length (e.g., a half-length) of one or more fractures, an aperture size for one or more fractures, a conductivity at a perforation, wellbore or casing features, or the like.

For example, an oilfield model may include a model of a reservoir having a number NL layers with a permeability of PB millidarcy (mD), a porosity of PY %, an initial water saturation ratio of S, and an initial pressure of P pounds per square inch absolute (psia), and a well system having a production well with a number NF hydraulic fractures each with a half-length of HL feet, an aperture of A inches, and a conductivity C and porosity PYP % at the perforation. Any or all of NL, PB, PY, S, P, NF, H, L A, C, and/or PYP can be adjustable parameters of the oilfield model. Initial values for adjustable parameters such as NL, PB, PY, S, P, NF, H, L A, C, and/or PYP can be determined based on known geophysical features of the oilfield, reservoir and/or well system components and/or measurements obtained during drilling and/or downhole (e.g., wireline) measurements before or during the production stage of the wellbore.

At block 204, a prior probability distribution may be provided for the at least one adjustable parameter. The prior probability distribution for each adjustable parameter may be a simple range, a weighted range, or a collection of weighted ranges (as examples). The prior probability distributions for adjustable parameters such as NL, PB, PY, S, P, NF, H, L A, C, and/or PYP can be determined based on known geophysical features of the oilfield, reservoir and/or well system components and/or measurements obtained during drilling and/or wireline measurement during the production stage of the wellbore.

At block 206, for each of multiple historical times, a measurement value from the oilfield may be obtained. The historical times may include times that span an entire history of a well system (e.g., the entire history of one or more production wells in the well system). For example, the measurement values may include surface flow rate measurements obtained by a flow sensor such as flow sensor 145 of FIG. 1 and/or surface pressure measurements obtained by a surface pressure sensor such as pressure sensor 147 of FIG. 1.

At block 208, for each of the multiple historical times, one or more processors may execute code or instructions stored in a non-transitory machine-readable medium to generate an output value of the model using the at least one adjustable parameter. For example, for a particular set of test parameter values (e.g., for initial or modified values of NL, PB, PY, S, P, NF, H, L A, C, and/or PYP), the processor calculates a model surface flow rate and a model surface pressure at each of the multiple historical times. In one illustrative example, initial values of NL, PB, PY, S, P, NF, H, L A, C, and/or PYP corresponding, respectively, to values of 12 layers with a permeability of 0.002 mD, a porosity of 25%, an initial water saturation ratio of 0.2, and an initial pressure of 3500 psia, and a well system having a production well with 12 hydraulic fractures each with a half-length of 500 feet, an aperture of 0.1 inches, and a conductivity of 3 mD and porosity of 30% at the perforation, may be used to compute an initial model surface flow rate and an initial model surface pressure at each of the multiple historical times. For later iterations of the operations of block 208 (e.g., after modifications of the adjustable parameters using prior probability distributions for each parameter and using a model error), an additional model surface flow rate and an additional model surface pressures can be generated at each of the multiple historical times, for each modified set of adjustable parameters.

At block 210, the measurement value for each historical time may be compared (e.g., by the processor) with the output value of the model for that historical time. Comparing the measurement value and the output value may include subtracting the measurement value and the output value to determine a difference at each historical time.

At block 212, the processor may determine a model error associated with the at least one adjustable parameter based on the comparing. For example, the processor may compute the model error by summing the squares or the absolute values of the differences generated at block 210 for all of the historical times.

At block 214, the processor may apply a modification to the at least one adjustable parameter based on the prior probability distribution and the model error. As indicated by arrow 221, the processor may repeat the computing of block 208, the comparing of block 210, the determining of block 212, and the applying of block 214, until convergence of the model error (e.g., until the model error is below a threshold error and/or until the changes in the model error for each repetition fail to decrease by more than a convergence threshold), to generate a history-matched oilfield model that facilitates well system operations for the oilfield.

At block 216, the history matched-model oilfield model that facilitates well system operations for the oilfield may be provided (e.g., by the processor to control unit 132) for modification of production operations such as by modifying an amount or pressure of an injection fluid of an injection well in the oilfield and/or by determination of a new location for a new well and/or drilling of the new well at the determined new location.

In this way, one or more of the operations described above in connection with blocks 208-216 can be performed to generate a history-matched oilfield model that facilitates well system operations for the oilfield, by performing a Bayesian optimization of at least one adjustable parameter using modifications to the at least one adjustable parameter based on a prior probability distribution, using measurement values and corresponding model prediction values, each generated using a corresponding modification of the at least one adjustable parameter. In this way, the process 200 can generate a history-matched oilfield model for an oilfield that includes a reservoir and well system that includes a production well and an injection well in fluid communication with the reservoir and a the oilfield can be modified based on the history-matched oilfield model, by (for example) at least one of modifying operation of the injection well (e.g., by modifying a rate or pressure of an injection fluid) and drilling a new well to the reservoir.

Processing performed for the process 200 by any appropriate component described herein may be performed only uphole, only downhole, or both (e.g., in a distributed processing operation). Processing performed for the process 200 by any appropriate component described herein may be performed in the field and/or remotely.

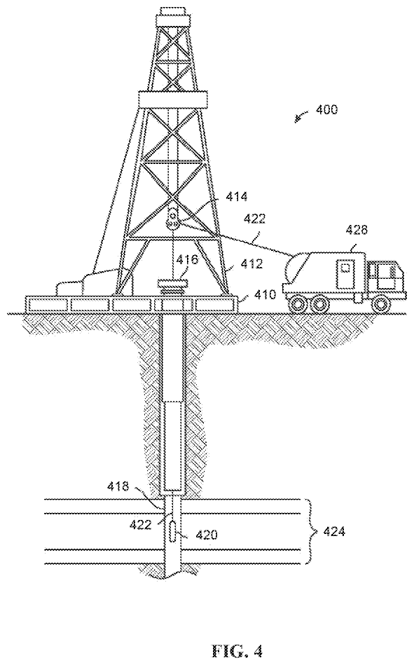

FIGS. 3 and 4, respectively, illustrate a drilling assembly that can be operated based on a history-matched model (generated using the Bayesian optimization operations described above in connection with FIG. 2), and a logging assembly that can be used to obtain measurements in additional to surface flow and pressure measurements (e.g., periodically) that can be used to determine initial parameter values, parameter prior probability distributions, and/or direct measurements of parameters that can be used during a Bayesian optimization process.

More specifically, FIG. 3 illustrates an exemplary drilling assembly 300 for implementing one or more of the operations described herein. It should be noted that while FIG. 3 generally depicts a land-based drilling assembly, those skilled in the art will readily recognize that the principles described herein are equally applicable to subsea drilling operations that employ floating or sea-based platforms and rigs, without departing from the scope of the disclosure.

In one or more implementations, the process 200 described above begins after the drilling assembly 300 drills a wellbore 316 penetrating a subterranean formation 318. In one or more implementations, the process 200 described above begins after months or years of production in a first wellbore 316 to provide a history-matched reservoir model that informs the location and/or operation of the drilling assembly 300 to drill another wellbore 316 penetrating the subterranean formation 318. As illustrated, the drilling assembly 300 may include a drilling platform 302 that supports a derrick 304 having a traveling block 306 for raising and lowering a drill string 308. The drill string 308 may include, but is not limited to, drill pipe and coiled tubing, as generally known to those skilled in the art. A kelly 310 supports the drill string 308 as it is lowered through a rotary table 312. A drill bit 314 is attached to the distal end of the drill string 308 and is driven either by a downhole motor and/or via rotation of the drill string 308 from the well surface. As the drill bit 314 rotates, it creates the wellbore 316 that penetrates various subterranean formations 318.

A pump 320 (e.g., a mud pump) circulates drilling mud 322 through a feed pipe 324 and to the kelly 310, which conveys the drilling mud 322 downhole through the interior of the drill string 408 and through one or more orifices in the drill bit 314. The drilling mud 322 is then circulated back to the surface via an annulus 326 defined between the drill string 308 and the walls of the wellbore 316. At the surface, the recirculated or spent drilling mud 322 exits the annulus 326 and may be conveyed to one or more fluid processing unit(s) 328 via an interconnecting flow line 330. After passing through the fluid processing unit(s) 328, a “cleaned” drilling mud 322 is deposited into a nearby retention pit 332 (i.e., a mud pit). While illustrated as being arranged at the outlet of the wellbore 316 via the annulus 326, those skilled in the art will readily appreciate that the fluid processing unit(s) 328 may be arranged at any other location in the drilling assembly 300 to facilitate its proper function, without departing from the scope of the scope of the disclosure.

Chemicals, fluids, additives, and the like may be added to the drilling mud 322 via a mixing hopper 334 communicably coupled to or otherwise in fluid communication with the retention pit 332. The mixing hopper 334 may include, but is not limited to, mixers and related mixing equipment known to those skilled in the art. In other implementations, however, the chemicals, fluids, additives, and the like may be added to the drilling mud 322 at any other location in the drilling assembly 300. In at least one implementation, for example, there may be more than one retention pit 332, such as multiple retention pits 332 in series. Moreover, the retention pit 332 may be representative of one or more fluid storage facilities and/or units where the chemicals, fluids, additives, and the like may be stored, reconditioned, and/or regulated until added to the drilling mud 322.

The processor 338 may be a portion of computer hardware used to implement the various illustrative operations, blocks, modules, elements, components, methods, and algorithms described herein. The processor 338 may be configured to execute one or more sequences of instructions, programming stances, or code stored on a non-transitory, computer-readable medium. The processor 338 can be, for example, a general purpose microprocessor, a microcontroller, a digital signal processor, an application specific integrated circuit, a field programmable gate array, a programmable logic device, a controller, a state machine, a gated logic, discrete hardware components, an artificial neural network, or any like suitable entity that can perform calculations or other manipulations of data. In some implementations, computer hardware can further include elements such as, for example, a memory (e.g., random access memory (RAM), flash memory, read only memory (ROM), programmable read only memory (PROM), erasable programmable read only memory (EPROM)), registers, hard disks, removable disks, CD-ROMS, DVDs, or any other like suitable storage device or medium.

Executable sequences described herein can be implemented with one or more sequences of code contained in a memory. In some implementations, such code can be read into the memory from another machine-readable medium. Execution of the sequences of instructions contained in the memory can cause a processor 338 to perform the process steps described herein. One or more processors 338 in a multi-processing arrangement can also be employed to execute instruction sequences in the memory. In addition, hard-wired circuitry can be used in place of or in combination with software instructions to implement various implementations described herein. Thus, the present implementations are not limited to any specific combination of hardware and/or software.

As used herein, a machine-readable medium will refer to any medium that directly or indirectly provides instructions to the processor 338 for execution. A machine-readable medium can take on many forms including, for example, non-volatile media, volatile media, and transmission media. Non-volatile media can include, for example, optical and magnetic disks. Volatile media can include, for example, dynamic memory. Transmission media can include, for example, coaxial cables, wire, fiber optics, and wires that form a bus. Common forms of machine-readable media can include, for example, floppy disks, flexible disks, hard disks, magnetic tapes, other like magnetic media, CD-ROMs, DVDs, other like optical media, punch cards, paper tapes and like physical media with patterned holes, RAM, ROM, PROM, EPROM and flash EPROM. Processor 338 may be implemented in drilling assembly 300, in another control assembly associated with a production well or injection well, or as part of control unit 132 of FIG. 1 (as examples).

The drilling assembly 300 may further include a bottom hole assembly (BHA) coupled to the drill string 308 near the drill bit 314. The BHA may comprise various downhole measurement tools such as, but not limited to, measurement-while-drilling (MWD) and logging-while-drilling (LWD) tools, which may be configured to take downhole and/or uphole measurements of the surrounding subterranean formations 318. Along the drill string 308, logging while drilling (LWD) or measuring while drilling (MWD) equipment 336 is included. In one or more implementations, the drilling assembly 300 involves drilling the wellbore 316 while the logging measurements are made with the LWD/MWD equipment 336. More generally, the methods described herein involve introducing a logging tool into the wellbore that is capable of determining wellbore parameters, including mechanical properties of the formation. The logging tool may be an LWD logging tool, a MWD logging tool, a wireline logging tool, slickline logging tool, and the like. Further, it is understood that any processing performed by the logging tool may occur only uphole, only downhole, or at least some of both (i.e., distributed processing).

According to the present disclosure, the LWD/MWD equipment 336 may include a stationary acoustic sensor and a moving acoustic sensor used to detect the flow of fluid flowing into and/or adjacent the wellbore 316. In an example, the stationary acoustic sensor may be arranged about the longitudinal axis of the LWD/MWD equipment 336, and, thus, of the wellbore 316 at a predetermined fixed location within the wellbore 316. The moving acoustic sensor may be arranged about the longitudinal axis of the LWD/MWD equipment 336, and, thus, of the wellbore 316, and is configured to move along the longitudinal axis of the wellbore 316. However, the arrangement of the stationary acoustic sensor and the moving acoustic sensor is not limited thereto and the acoustic sensors may be arranged in any configuration as required by the application and design.

The LWD/MWD equipment 336 may transmit the measured data to a processor 338 at the surface over a wired or wireless connection. Transmission of the data is generally illustrated at line 340 to demonstrate communicable coupling between the processor 338 and the LWD/MWD equipment 336 and does not necessarily indicate the path to which communication is achieved. The stationary acoustic sensor and the moving acoustic sensor may be communicably coupled to the line 340 used to transfer measurements and signals from the BHA to the processor 438 that processes the acoustic measurements and signals received by acoustic sensors (e.g., stationary acoustic sensor, moving acoustic sensor) and/or controls the operation of the BHA. In the subject technology, the LWD/MWD equipment 336 may be capable of logging analysis of the subterranean formation 318 proximal to the wellbore 316.

In some implementations, part of the processing may be performed by a telemetry module (not shown) in combination with the processor 338. For example, the telemetry module may pre-process the individual sensor signals (e.g., through signal conditioning, filtering, and/or noise cancellation) and transmit them to a surface data processing system (e.g., the processor 338) for further processing. It is appreciated that any processing performed by the telemetry module may occur only uphole, only downhole, or at least some of both (i.e., distributed processing).

In various implementations, the processed acoustic signals are evaluated in conjunction with measurements from other sensors (e.g., temperature and surface well pressure measurements) to evaluate flow conditions and overall well integrity. The telemetry module may encompass any known means of downhole communication including, but not limited to, a mud pulse telemetry system, an acoustic telemetry system, a wired communications system, a wireless communications system, or any combination thereof. In certain implementations, some or all of the measurements taken by the stationary acoustic sensor and the moving acoustic sensor may also be stored within a memory associated with the acoustic sensors or the telemetry module for later retrieval at the surface upon retracting the drill string 308.

FIG. 4 illustrates a logging assembly 400 having a wireline system suitable for implementing one or more operations described herein. For example, logging assembly 400 may be used to obtain measurements that are used (e.g., in combination with other measurements such as geological, seismic, or other survey data) to identify initial values and/or prior probability distributions for adjustable parameters of an oilfield model. As illustrated, a platform 410 may be equipped with a derrick 412 that supports a hoist 414. Drilling oil and gas wells, for example, are commonly carried out using a string of drill pipes connected together so as to form a drilling string that is lowered through a rotary table 416 into a wellbore 418. Here, it is assumed that the drilling string has been temporarily removed from the wellbore 418 to allow a logging tool 420 (and/or any other appropriate wireline tool) to be lowered by wireline 422, slickline, coiled tubing, pipe, downhole tractor, logging cable, and/or any other appropriate physical structure or conveyance extending downhole from the surface into the wellbore 418. Typically, the logging tool 420 is lowered to a region of interest and subsequently pulled upward at a substantially constant speed. During the upward trip, instruments included in the logging tool 420 may be used to perform measurements on the subterranean formation 424 adjacent the wellbore 418 as the logging tool 420 passes. Further, it is understood that any processing performed by the logging tool 420 may occur only uphole, only downhole, or at least some of both (i.e., distributed processing).

The logging tool 420 may include one or more wireline instrument(s) that may be suspended into the wellbore 418 by the wireline 422. The wireline instrument(s) may include the stationary acoustic sensor and the moving acoustic sensor, which may be communicably coupled to the wireline 422. The wireline 422 may include conductors for transporting power to the wireline instrument and also facilitate communication between the surface and the wireline instrument. The logging tool 420 may include a mechanical component for causing movement of the moving acoustic sensor.

Additionally or alternatively, in an example (not explicitly illustrated), the acoustic sensors may be attached to or embedded within the one or more strings of casing lining the wellbore 418 and/or the wall of the wellbore 418 at an axially spaced pre-determined distance.

A logging facility 428, shown in FIG. 4 as a truck, may collect measurements from the acoustic sensors (e.g., the stationary acoustic sensor, the moving acoustic sensor), and may include the processor 438 for controlling, processing, storing, and/or visualizing the measurements gathered by the acoustic sensors. The processor 438 may be communicably coupled to the wireline instrument(s) by way of the wireline 422. Alternatively, the measurements gathered by the logging tool 420 may be transmitted (wired or wirelessly) or physically delivered to computing facilities off-site where the methods and processes described herein may be implemented.

FIG. 5 illustrates a schematic diagram of a set of general components of an example computing device 500. In this example, the computing device 500 includes a processor 502 (e.g., an implementation of processor 338) for executing instructions that can be stored in a memory device or element 504. The computing device 500 can include many types of memory, data storage, or non-transitory computer-readable storage media, such as a first data storage for program instructions for execution by the processor 502, a separate storage for images or data, a removable memory for sharing information with other devices, etc.

The computing device 500 typically may include some type of display element 506, such as a touch screen or liquid crystal display (LCD). As discussed, the computing device 500 in many embodiments will include at least one input element 510 able to receive conventional input from a user. This conventional input can include, for example, a push button, touch pad, touch screen, wheel, joystick, keyboard, mouse, keypad, or any other such device or element whereby a user can input a command to the device. In some embodiments, however, such the computing device 500 might not include any buttons at all, and might be controlled only through a combination of visual and audio commands, such that a user can control the computing device 500 without having to be in contact with the computing device 500. In some embodiments, the computing device 500 of FIG. 5 can include one or more network interface elements 508 for communicating over various networks, such as a Wi-Fi, Bluetooth, RF, wired, or wireless communication systems. The computing device 500 in many embodiments can communicate with a network, such as the Internet, and may be able to communicate with other such computing devices.

As discussed herein, different approaches can be implemented in various environments in accordance with the described embodiments. For example, FIG. 6 illustrates a schematic diagram of an example of an environment 600 for implementing aspects in accordance with various embodiments. As will be appreciated, although a client-server based environment is used for purposes of explanation, different environments may be used, as appropriate, to implement various embodiments. The system includes an electronic client device 602, which can include any appropriate device operable to send and receive requests, messages or information over an appropriate network 604 and convey information back to a user of the device. Examples of such client devices include personal computers, cell phones, handheld messaging devices, laptop computers, and the like.

The network 604 can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Computing over the network 604 can be enabled via wired or wireless connections and combinations thereof. In this example, the network includes the Internet, as the environment includes a server 606 for receiving requests and serving content in response thereto, although for other networks, an alternative device serving a similar purpose could be used, as would be apparent to one of ordinary skill in the art.

The client device 602 may represent the computing device 500 of FIG. 5, and the server 606 may represent off-site computing facilities in one implementation.

The server 606 typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via computing links, using one or more computer networks or direct connections. However, it will be appreciated by those of ordinary skill in the art that such a system could operate equally well in a system having fewer or a greater number of components than are illustrated in FIG. 6. Thus, the depiction of the environment 600 in FIG. 6 should be taken as being illustrative in nature and not limiting to the scope of the disclosure.

Storage media and other non-transitory computer readable media for containing code, or portions of code, can include any appropriate storage media used in the art, such as but not limited to volatile and non-volatile, removable and non-removable media implemented in any method or technology for storage of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various implementations.

Various examples of aspects of the disclosure are described below as clauses for convenience. These are provided as examples, and do not limit the subject technology.

Clause A. A method, comprising: generating a history-matched oilfield model for an oilfield that includes a reservoir and well system that includes a production well and an injection well in fluid communication with the reservoir, wherein the history-matched oilfield model facilitates modifying the oilfield based on the history-matched oilfield model, wherein modifying the oilfield comprises at least one of modifying operation of the injection well and drilling a new well to the reservoir, and wherein generating the history-matched oilfield model comprises: providing an oilfield model comprising at least one adjustable parameter that corresponds to a physical characteristic of the oilfield; providing a prior probability distribution for the at least one adjustable parameter; obtaining, for each of a plurality of historical times, a measurement value from the oilfield; computing, for each of the plurality of historical times, an output value of the model using the at least one adjustable parameter; comparing the measurement value with the output value of the model for each of the plurality of historical times; determining a model error associated with the at least one adjustable parameter based on the comparing; applying a modification to the at least one adjustable parameter based on the prior probability distribution and the model error; and repeating the computing, comparing, determining, and applying until convergence of the model error, to generate a history-matched oilfield model that facilitates well system operations for the oilfield.

Clause B. A system comprising: at least one sensor configured to obtain fluid measurements associated with fluid flow in a production well in fluid communication with a reservoir in an oilfield, the oilfield including a well system that includes the production well and an injection well in fluid communication with the reservoir; a processor; and a memory device including instructions that, when executed by the processor, cause the processor to: generate a history-matched oilfield model that facilitates a modification of the oilfield to enhance production from the reservoir, wherein the modification of the oilfield comprises at least one of a modification of an operation of the injection well and drilling a new well to the reservoir, and wherein the processor is configured to generate the history-matched oilfield model by performing operations that include: obtaining an oilfield model comprising at least one adjustable parameter that corresponds to a physical characteristic of the oilfield; obtaining a prior probability distribution for the at least one adjustable parameter; obtaining, for a plurality of historical times, a plurality of measurement values from the oilfield; and performing a Bayesian optimization of the at least one adjustable parameter using modifications to the at least one adjustable parameter based on the prior probability distribution, using the plurality of measurement values and a corresponding plurality of model prediction values, each generated using a corresponding modification of the at least one adjustable parameter.

Clause C. A non-transitory computer-readable medium including instructions stored therein that, when executed by at least one computing device, cause the at least one computing device to perform operations comprising: providing an oilfield model comprising at least one adjustable parameter that corresponds to a physical characteristic of the oilfield; providing a prior probability distribution for the at least one adjustable parameter; obtaining, for each of a plurality of historical times, a measurement value from the oilfield; computing, for each of the plurality of historical times, an output value of the model using the at least one adjustable parameter; comparing the measurement value with the output value of the model for each of the plurality of historical times; determining a model error associated with the at least one adjustable parameter based on the comparing; applying a modification to the at least one adjustable parameter based on the prior probability distribution; and repeating the computing, comparing, determining, and applying until convergence of the model error, to generate a history-matched oilfield model that facilitates well system operations for the oilfield.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A method, comprising:
generating a history-matched oilfield model for an oilfield in real time that includes a reservoir and well system, wherein the well system includes at least one production well and at least one injection well in fluid communication with the reservoir, wherein the history-matched oilfield model facilitates modifying the oilfield, wherein modifying the oilfield comprises at least one of modifying operation of the at least one injection well and drilling a new well to the reservoir, and wherein generating the history-matched oilfield model comprises:
providing an oilfield model comprising at least one adjustable parameter that corresponds to a physical characteristic of an oilfield;
providing a prior probability distribution for the at least one adjustable parameter;
obtaining, for each of a plurality of historical times, a measurement value from the oilfield;
computing, for each of the plurality of historical times, an output value of the oilfield model using the at least one adjustable parameter;
comparing the measurement value with the output value of the oilfield model for each of the plurality of historical times;
determining a model error associated with the at least one adjustable parameter based on the comparing;
applying a modification to the at least one adjustable parameter based on the prior probability distribution and the model error; and
repeating the computing, comparing, determining, and applying until convergence of the model error.

2. The method of claim 1, wherein the plurality of historical times spans an entire history of the at least one production well.

3. The method of claim 1, wherein the at least one adjustable parameter comprises at least one geophysical parameter associated with the reservoir.

4. The method of claim 3, wherein the at least one geophysical parameter comprises at least one of a permeability and a porosity of a formation layer.

5. The method of claim 4, wherein the at least one adjustable parameter further comprises a fluid parameter associated with the reservoir.

6. The method of claim 5, wherein the fluid parameter comprises a water saturation value or a pressure.

7. The method of claim 5, wherein the fluid parameter comprises a bottom-hole pressure associated with the at least one production well.

8. The method of claim 5, wherein the at least one adjustable parameter comprises a well system parameter selected from the group consisting of a number of fractures, a half-length of a fracture, an aperture size of a fracture, or a conductivity at a perforation.

9. The method of claim 1, wherein modifying the oilfield comprises modifying the operation of the at least one injection well by injecting a fluid into the reservoir via the at least one injection well in the oilfield based on the history-matched oilfield model.

10. The method of claim 1, wherein the measurement value comprises a surface flow rate or a surface pressure of the at least one production well.

11. A system comprising:
at least one sensor configured to obtain fluid measurements associated with fluid flow in at least one production well in fluid communication with a reservoir in an oilfield, the oilfield including a well system that includes the at least one production well and an injection well or wells in fluid communication with the reservoir;
a processor; and
a memory device including instructions that, when executed by the processor, cause the processor to:
generate a history-matched oilfield model that facilitates a modification of the oilfield to enhance production from the reservoir, wherein the modification of the oilfield comprises at least one of a modification of an operation of the at least one injection well and drilling a new well to the reservoir, and wherein the processor is configured to generate the history-matched oilfield model by performing operations that include:
obtaining an oilfield model comprising at least one adjustable parameter that corresponds to a physical characteristic of an oilfield;
obtaining a prior probability distribution for the at least one adjustable parameter;
obtaining, for a plurality of historical times, a plurality of measurement values from the oilfield; and
performing a Bayesian optimization of the at least one adjustable parameter using modifications to the at least one adjustable parameter based on the prior probability distribution, using the plurality of measurement values and a corresponding plurality of model prediction values, each generated using a corresponding modification of the at least one adjustable parameter.

12. The system of claim 11, wherein the plurality of historical times spans an entire history of the at least one production well.

13. The system of claim 11, wherein the at least one adjustable parameter comprises at least one geophysical parameter associated with the reservoir.

14. The system of claim 13, wherein the at least one geophysical parameter comprises at least one of a permeability and a porosity of a formation layer.

15. The system of claim 14, wherein the at least one adjustable parameter further comprises a fluid parameter associated with the reservoir.

16. The system of claim 15, wherein the fluid parameter comprises a water saturation value or a pressure.

17. The system of claim 15, wherein the fluid parameter comprises a bottom-hole pressure associated with the at least one production well.

18. The system of claim 15, wherein the at least one adjustable parameter comprises a well system parameter selected from the group consisting of a number of fractures, a half-length of a fracture, an aperture size of a fracture, or a conductivity at a perforation.

19. The system of claim 11, wherein the modification of the operation of the at least one injection well comprises injecting a fluid into the reservoir via the at least one injection well based on the history-matched oilfield model.

20. A non-transitory computer-readable medium including instructions stored therein that, when executed by at least one computing device, cause the at least one computing device to perform operations comprising:
generating a history-matched oilfield model for an oilfield in real time that includes a reservoir and well system that includes at least one production well and at least one injection well in fluid communication with the reservoir, wherein the history-matched oilfield model facilitates modifying the oilfield by performing at least one of modifying operation of the at least one injection well and drilling a new well to the reservoir, and wherein generating the history-matched oilfield model comprises:
providing an oilfield model comprising at least one adjustable parameter that corresponds to a physical characteristic of an oilfield;
providing a prior probability distribution for the at least one adjustable parameter;
obtaining, for each of a plurality of historical times, a measurement value from the oilfield;
computing, for each of the plurality of historical times, an output value of the oilfield model using the at least one adjustable parameter;
comparing the measurement value with the output value of the oilfield model for each of the plurality of historical times;
determining a model error associated with the at least one adjustable parameter based on the comparing;
applying a modification to the at least one adjustable parameter based on the prior probability distribution; and
repeating the computing, comparing, determining, and applying until convergence of the model error, to generate a history-matched oilfield model that facilitates well system operations for the oilfield.
